(19) United States
(12) Patent Application Publication
(10) Pub. No.: US 2003/0002634 A1
(43) Pub. Date: Jan. 2, 2003

(54) Event notification in a unified message system using an event notification server

(76) Inventors: Virad Gupta, Fremont, CA (US); Shital Mehta, Sunnyvale, CA (US)

Correspondence Address: STERNE, KESSLER, GOLDSTEIN & FOX PLLC, 1100 NEW YORK AVENUE, N.W., SUITE 600, WASHINGTON, DC, 20005-3934, US

(21) Appl. No.: 09/893,741

(22) Filed: Jun. 29, 2001

(51) Int. Cl. H04M 11/00

(52) U.S. Cl. 379/88.13

(57) ABSTRACT

A system, method, and computer program product for monitoring event requests in a unified messaging system and generating event notifications upon the occurrence of specified events. The event notification system comprises an email server for storing a plurality of email messages. The event notification system further comprises at least one client from which at least one event request is initiated. A message handler is also provided. The message handler monitors the event requests, forwards the event requests to the email server, and forwards an event response based on the events requested to the client that initiated the request. An event listener that passively and actively monitors event requests occurring within the event notification system and generates an event notification when the event requests correspond to a subscriber event registration is also present. The event listener comprises a registration manager that receives and stores one or more event notification requests from the event notification requesters and a notification generator for generating the event notifications.

### BACKGROUND OF THE INVENTION

1. Field of the Invention

The present invention relates to the field of unified messaging systems and more particularly to the generation of event notifications within these systems.

2. Related Art

Most companies utilize several channels of communications. Examples of traditional channels include voice-mail, email, and facsimile. These communications channels give associates, customers, or other message senders relatively easy access to the message receiver.

During a typical business day, a person can receive dozens of calls, faxes, voice-mail messages, and email messages. Considering that these communications arrive in different forms and in different locations via different machines, managing it all can be quite challenging. Unified messaging systems have been developed to meet this challenge.

Unified messaging systems typically combine proprietary email servers (back-end) with proprietary unified message applications (front-end). The advantage of using “off the shelf” email servers on the back-end is that these systems are industry proven and allow for shorter development cycles for front-end applications. While such systems do allow the user to operate both the voice mail system and the email system from a single location, there are some drawbacks with respect to event notifications.

There are industry standards for message retrieval protocols which these email servers support (such as POP, IMAP, etc.), however, there is no standard way to notify an external entity about events such as “user log-on/log-off”, “message read”, “message deleted”, etc. Knowledge of these events is required by any unified messaging application to support message waiting indication/notification and also to maintain synchronization between the information stored on the email server and that stored with the application itself. There are some email servers that provide proprietary methods to access the above mentioned events. One example being call-back APIs provided by IPlanet 5.0 Mail server, available from IPlanet E-commerce Solutions, a Sun-Netscape alliance. However, the problem in using these proprietary methods is that it ties the unified messaging solution provider to a particular email server. If the solution provider wants to use any other email server, new interfaces will have to be developed to get these event notifications from other email servers (provided they do have some methods of doing event notification). Therefore, what is needed is an event notification mechanism which is independent of the email server.

### SUMMARY OF THE INVENTION

The present invention provides a system, method, and computer program product for monitoring event requests in a unified messaging system and for generating event notifications upon the occurrence of specified events. In one embodiment, the event notification system includes an email server that stores a number of messages. In one example, the email server stores a number of email messages. The event notification system further includes at least one client from which at least one event request is initiated. A message handler is also provided. The message handler monitors the event requests, forwards the event requests to the email server, and forwards an event response to the client that initiated the request.

The present invention further includes an event listener. The event listener passively and actively monitors event requests occurring within the event notification system. The event listener is further used to generate an event notification when the event requested corresponds to a subscriber event registration. The event listener comprises a registration manager that receives and stores one or more event notification requests from the event notification requesters and a notification generator for generating the event notifications.

Further embodiments, features and advantages of the present invention, as well as the structure and operation of various embodiments of the present invention are described in detail below with reference to the accompanying drawings.

### BRIEF DESCRIPTION OF THE FIGURES

The present invention is described with reference to the accompanying drawings. In the drawings, like reference numbers generally indicate identical, functionally similar, and/or structurally similar elements. The drawing in which an element first appears is indicated by the left-most digit or digits in the corresponding reference number. The accompanying figures, which are incorporated herein and form part of the specification, illustrate the present invention and, together with the description, further serve to explain the principles of the invention and to enable a person skilled in the relevant art to make and use the invention.

FIG. 1A illustrates an example event notification system embodiment of the present invention.

FIG. 1B illustrates an example application of an event notification system embodiment of the present invention.

FIG. 1C illustrates a second example application of an event notification system embodiment of the present invention.

FIG. 2 illustrates an event notification server embodiment of the present invention.

FIG. 3 illustrates an example of a computer system embodiment of the present invention.

FIG. 4 is a flowchart diagram of a routine for passively monitoring event requests and generating event notifications in response to the event request according to an embodiment of the present invention.

FIG. 5A is a flowchart diagram of a routine for actively monitoring event requests and generating event notifications in response to the event request according to an embodiment of the present invention.

FIG. 5B illustrates an example implementation of the flowchart diagram depicted in FIG. 5A.

FIG. 6A is a flowchart diagram of a second routine for actively monitoring event requests and generating event notifications in response to the event requests according to an alternative embodiment of the present invention.

FIG. 6B illustrates an example implementation of the flowchart diagram depicted in FIG. 6A.

### DETAILED DESCRIPTION OF THE INVENTION

### Table of Contents

I. Overview

II. System Architecture

A. Event Notification System

B. Synchronization Module

C. Message Notification Module

III. Event Notification Process

A. Passive Monitoring

B. Active Monitoring

IV. Example Computer System

V. Conclusion

I. Overview

The present invention relates to a system, method, and computer program product for providing event notifications in a unified messaging system. The present invention allows for event notifications to be generated irrespective of the type of email server being accessed.

The present invention is described in terms of examples contained herein. This is for convenience only and is not intended to limit the application of the present invention. In fact, after reading the following description, it will be apparent to one skilled in the relevant art(s) how to implement the following invention in alternative embodiments.

The term “message” refers to any type of message including, but not limited to, electronic messages (email), voice messages (voice mail), and facsimiles (faxes).

The term “client” refers to any network device that can handle messages. A client can include a telephone client or email client. A client can be implemented on a telephone, computer, personal data assistant (PDA), palm device, set-top box, televison, processor or other type of network device.

II. System Architecture

A. Event Notification System

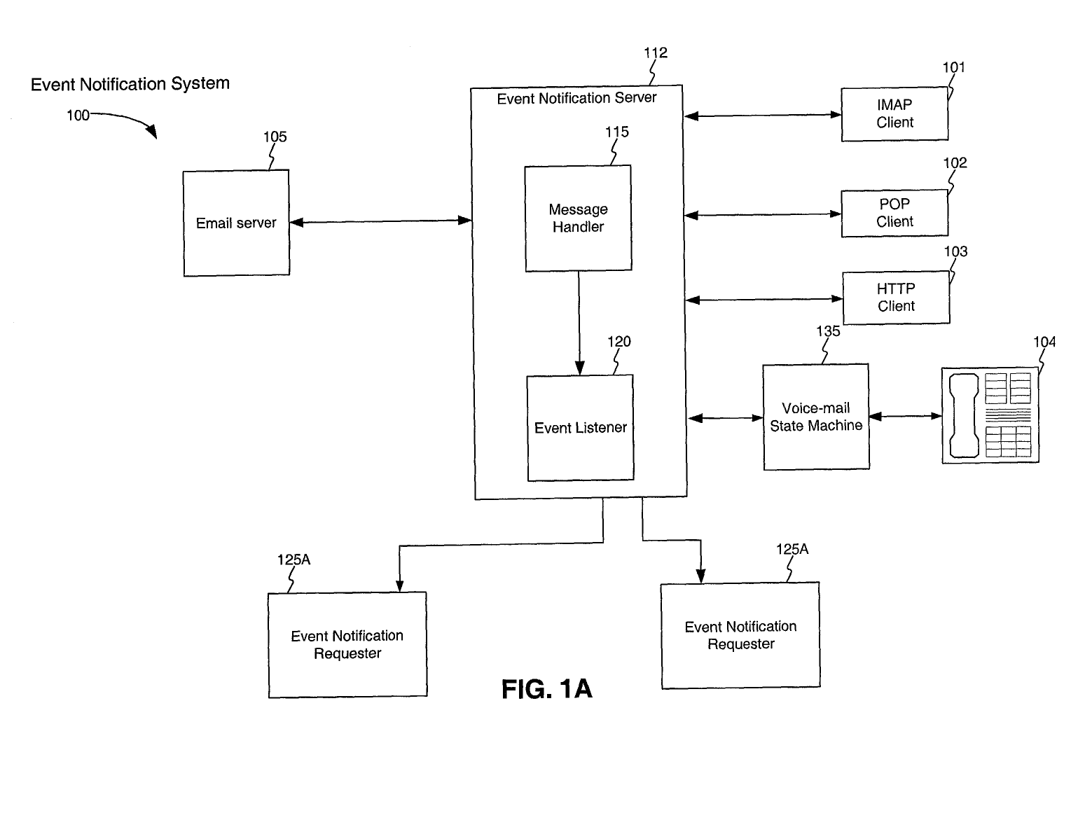

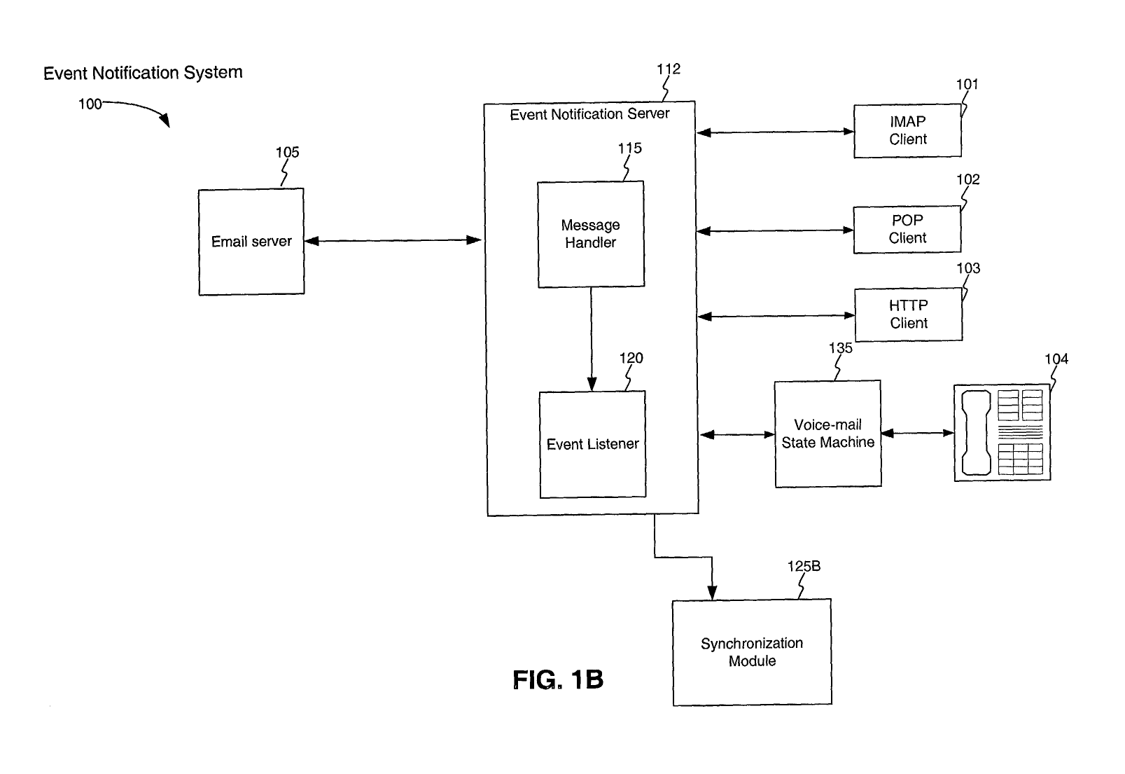

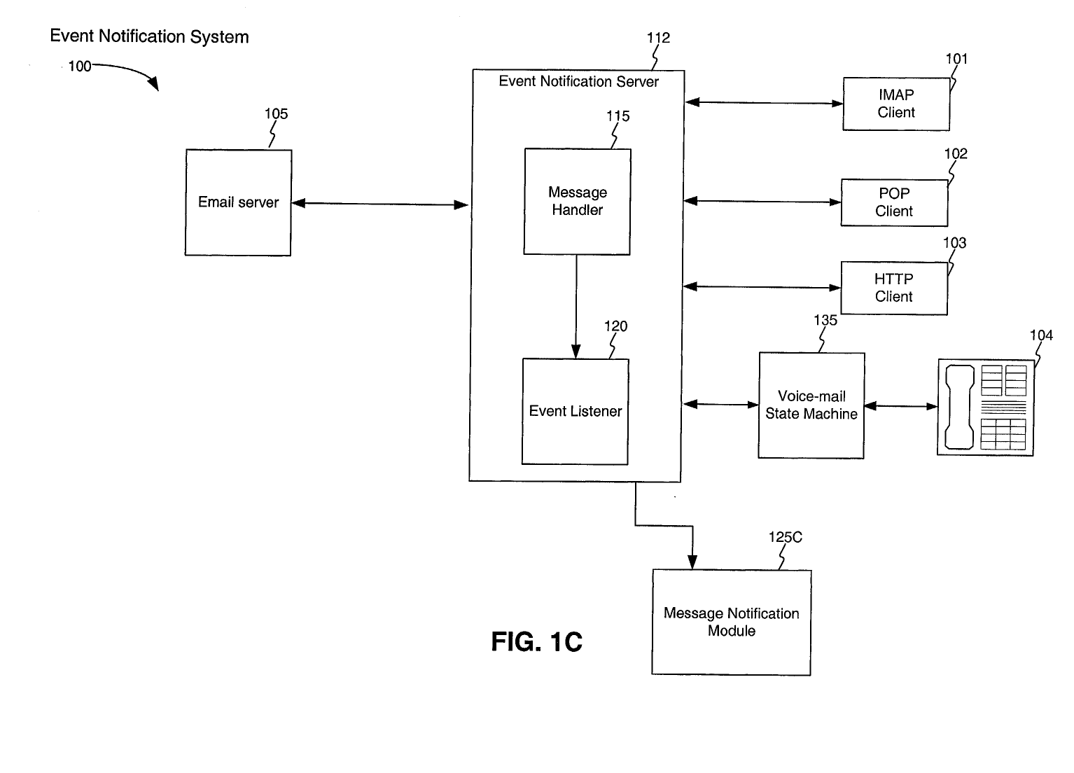

FIG. 1A is a block diagram depicting event notification system 100, a typical operational environment in which the various features of the present invention can be implemented. It is an advantage of the invention that it may be implemented in many different ways in many environments and on many different computers or computer systems. An embodiment of the present invention is represented by event notification server 112. Event notification server 112 is used to monitor the occurrence of events within event notification system 100.

In one embodiment, event notification server 112 passively monitors events. Passive monitoring is useful for events that can be identified, i.e., trapped, by simply monitoring a user session. Examples of such events include a user log-on or log-off.

In yet another embodiment, event notification server 112 actively monitors events. In active monitoring, event notification server 112 issues independent requests to gather additional information about a user session. In an embodiment, these requests are made to email servers. Event notification server 112 intercepts event requests initiated from the network devices depicted in FIG. 1A.

The network devices are referred to herein as “clients.” The clients depicted in this example are: an Internet Messaging Access Protocol (IMAP) client 101; a Post Office Protocol (POP) client 102; a Hypertext Transfer Protocol (HTTP) client 103; and a plain old telephone (POT) client 104. In an embodiment, clients 101-103 are general purpose computers and client 104 is a telephone. After reading this description, the configuration of such clients would be apparent to one of ordinary skill in the relevant art(s).

A voice-mail state machine 135 is coupled between telephone client 104 and event notification server 112.

Event notification server 112 intercepts event requests generated from the clients and event responses generated by email server 105. Email server 105 is configured to facilitate storage, retrieval, reading, and other functions associated with the handling of electronic mail (email). After reading this description, the configuration of email server 105 would be apparent to one of ordinary skill in the relevant art(s).

Event notification server 112 is further able to receive event notification registration requests from a plurality of event notification requesters 125A. Event notification requesters 125A are applications that need to be informed when events occur within event notification system 100. Examples of event notifications for which registration might be requested are user log-on and log-offs, messages being marked deleted or undeleted, messages being marked read or unread, and messages being marked heard or unheard. Additional examples of event notification requests are related to special flags set for a message such as, return receipt or acknowledgment that a message has been opened or listened to. Such examples of event notification requests are intended for example only and not limitation. Requests for notification of additional events can be made without departing from the spirit and scope of the present invention.

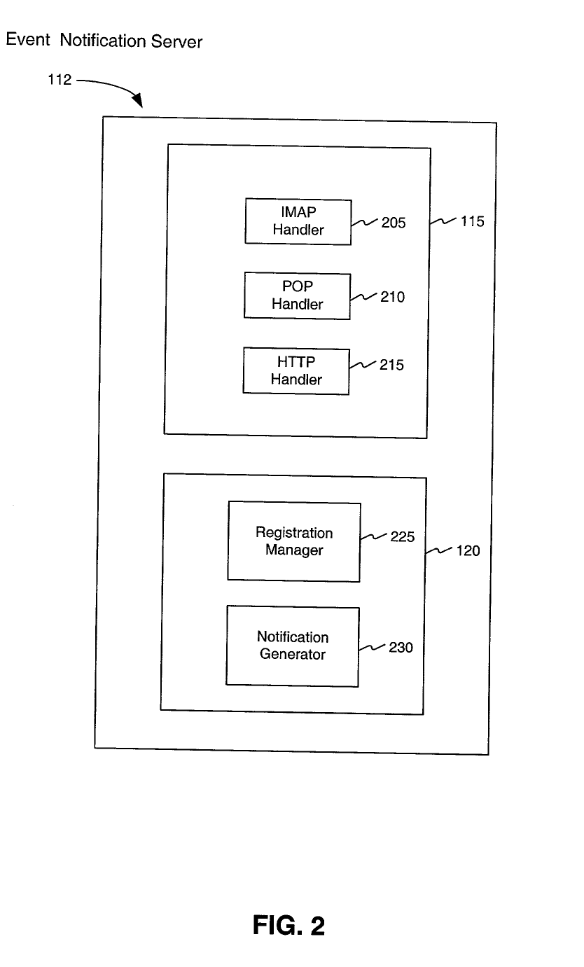

Event notification server 112 is further able to generate event notifications when registered events occur. To support this function, event notification server 112 is provided with a message handler 115 and an event listener 120. In this example, message handler 115 and event listener 120 are depicted as being embodied in a single device or “box” 112. This may not always be the case. In alternative embodiments, message handler 115 and event listener 112 can reside in separate devices or boxes. Message handler 115 is used to receive event requests from clients 101, 102, and 103. In turn, message handler 115 forwards such requests to email server 105. As responses to the event request are received from email server 105, they are forwarded to the clients 101-104 that initiated the request. Message handler 115 is further used to communicate the occurrence of events within event notification system 100 to event listener 120. Message handler 115 and event listener 120 will be described in further detail with reference to FIG. 2.

FIG. 2 is a more detailed diagram of event notification server 112. Event notification server 112 comprises a message handler 115. Message handler 115 includes a number of communication protocol handlers. In this example, three specific communication protocols are supported. Accordingly, the event notification server 112 comprises three communication protocol handlers: an IMAP handler 205, a POP handler 210, and an HTTP handler 215. In this fashion, event notification server 112 is generalized and does not depend on any particular communications protocol. This facilitates support for multiple communications protocols. In accordance with the example above, the IMAP handler 205 accepts IMAP requests from IMAP client 101. Similarly, the POP handler 210 accepts POP requests from POP client 102 and the HTTP handler 215 accepts HTTP communications requests from HTTP client 103. Event notification server 112 is further configured to accept communications from client 104. In this fashion, each of the clients 101, 102, 103, and 104 communicate with event notification server 112 in their native protocol. This has the advantage of allowing conventional software to be used within each client 101-104 with little or no modification. In other words, the event notification server 112 of the present invention is transparent to the clients 101-104.

Event notification server 112 is further comprised of an event listener 120. Event listener 120 is comprised of a registration manager 225 and a notification generator 230. Registration manager 225 is responsible for receiving registration requests from event notification requesters 125A and storing information regarding these registration requests. Notification generator 230 is responsible for generating event notifications in response to the occurrence of a registered event and sending such event notifications to the appropriate event notification requester. When an event occurs, the message handler 115 forwards the event request to the event listener 120. Event listener 120 checks to see if the event request is a registered event (i.e., has a corresponding request for notice registration), and if so, forwards notification of the event to the event notification requester 125A that registered to receive such notification.

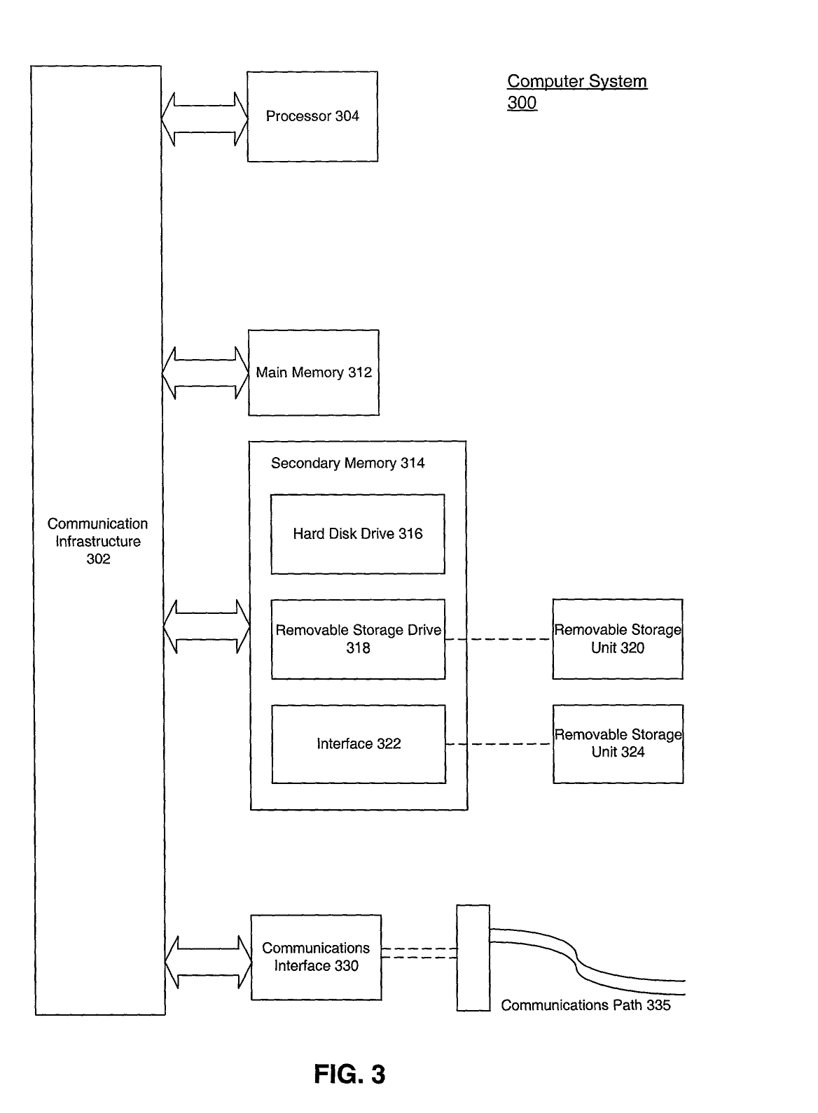

The present invention can be implemented in software, firmware, hardware, or any combination thereof. An example computer system, although not intended to limit the present invention, is described below with respect to FIG. 3.

B. Synchronization Module

FIG. 1B depicts an application of the present invention. Here, event notification requester 125A is a synchronization module 125B. Synchronization module 125B is responsible for maintaining the synchronization of message store in the unified messaging system.

C. Message Notification Module

FIG. 1C depicts yet another application of the present invention. Here, event notification requester 125A is a message notification module 125C. The message notification module 125C is responsible for providing indication that an email message, voice mail message, or fax is waiting to be retrieved. Indications might include illuminated lights or stuttered dial tones on a telephone, and icons or sound bytes on a general purpose computer.

III. Event Notification Process

A. Passive Monitoring

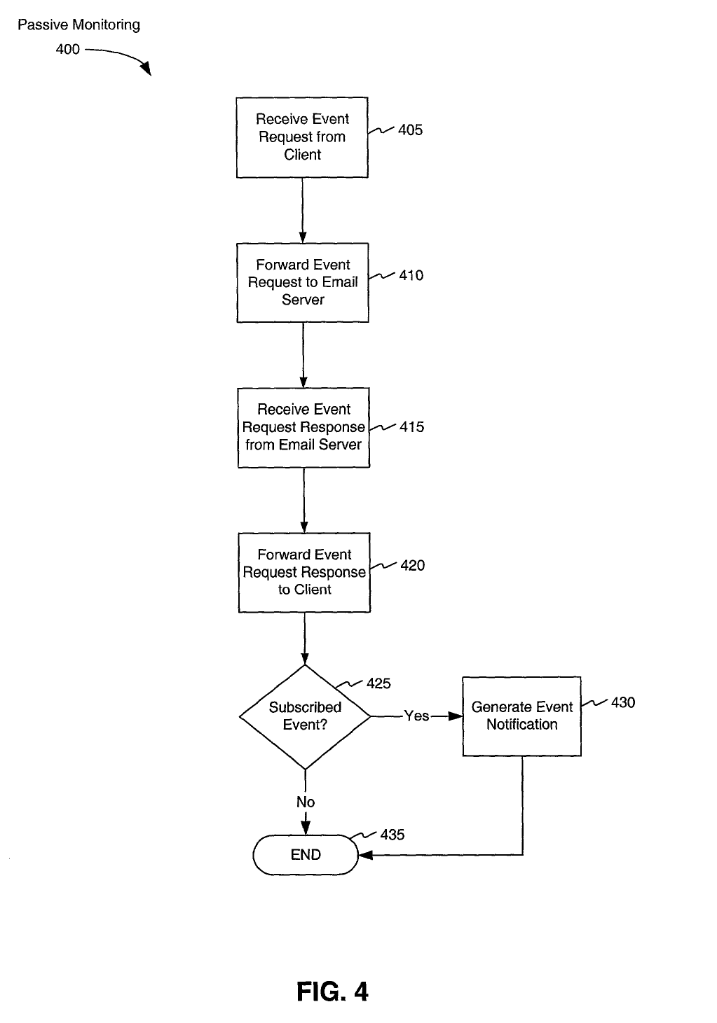

FIG. 4 is a flowchart of a method 400 (steps 405-435) showing passive monitoring for event requests and generation of event notifications according to an embodiment of the present invention.

To begin, in step 405, an event request is received by event notification server 112. Examples of such an event request include: requests to log-on and log-off. Event requests can be initiated from a client 101-104. For instance, a user requesting to read an email located in his inbox would result in the generation of a request to retrieve the particular email.

Next, in step 410, event notification server 112 forwards the event request to email server 105.

In step 415, the event request response is received by event notification server 112. In the example above, a typical event request response would be providing the user access to the email.

Next, in step 420, the event request response is forwarded by event notification server 112 to the client 101, 102, 103, or 104 that initiated the request.

Next, in step 425, a determination is made as to whether the event request is a subscribed event. Subscribed events are those events that an event notification requester 125A has registered to receive notification of from the event notification server 112. Examples of such subscribed events include a user request to log on or log off, requests to mark messages as read or unread, and requests to mark messages as deleted.

If the event request is a subscribed event, then in step 430, an event notification is generated by event listener 120. Continuing with the example above, assuming requests to read emails are subscribed events, the request to read a particular email would result in the generation of an event notification by event listener 120. The method ends in step 435.

B. Active Monitoring

In active monitoring the event notification server 112 issues independent requests to email server 105 for gathering additional information about the user session. These requests are not solicited by the email clients. This type of active monitoring is needed to provide message deletion notification, message waiting notification, etc. Active monitoring has to be done in the event notification server 112 itself utilizing the user's session. This is because notification is based on events which are specific to that particular session of the user which event notification server 112 is relaying. Hence this active monitoring cannot be done by an external entity on receiving notification from the event notification server 112.

There are two types of active monitoring which event notification server 112 does. In the first example, active monitoring is based on client requests. In this type of active monitoring, event notification server 112 issues relevant event queries (based on the client requests) to gather active information about a particular client request. The second example of active monitoring is not based on client requests. In this type of active monitoring, event notification server 112 issues event queries to the email server independent of any requests being received from the email client.

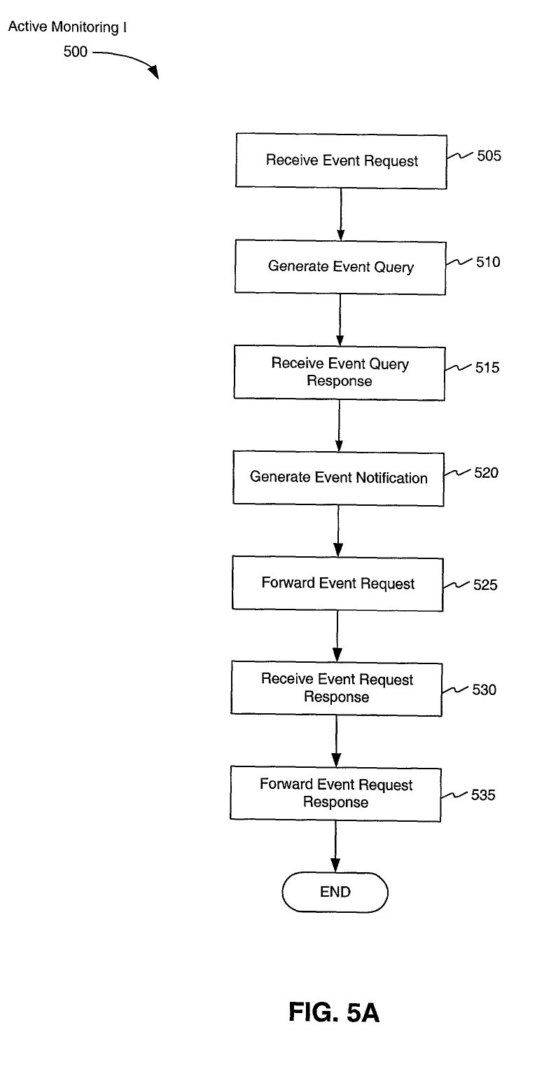

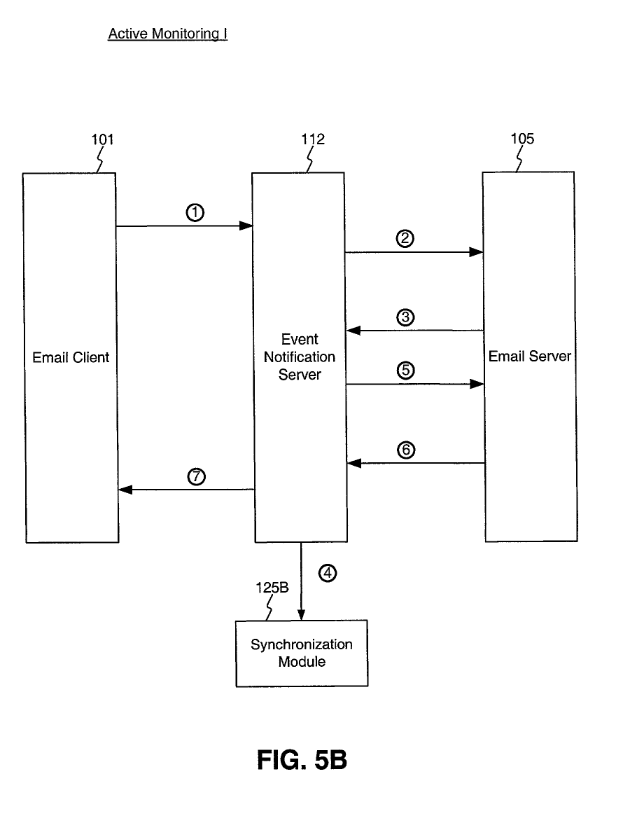

FIG. 5A is a flowchart of a method 500 (steps 505-535) for an embodiment according to the first type for active monitoring of event requests and generation of event notifications. This type used to facilitate generation of event notifications based on client requests.

In step 505, event notification server 112 receives an event request from one of the clients 101-104.

In step 510, event notification server 112 generates an event query. The event query is used to gather information about the client session.

In step 515, a response to the event query is received from email server 105.

In step 520, an event notification is generated by event listener 120. The event notification includes information provided in the response to the event query.

Next, in step 525, the event request is forwarded to email server 105.

In step 530, event notification server 112 receives an event request response from email server 105.

Finally, in step 535, event notification server 112 forwards the event request response to the client 101, 102,103, or 104 from which the event request was initiated.

FIG. 5B shows an example implementation of the first type of active monitoring (i.e., active monitoring based on client requests) according to flow 500 described above.

Event 1 (see step 505, FIG. 5A) depicts an email client issuing an “EXPUNGE” request.

Upon receipt of this request, in Event 2 (see step 510, FIG. 5A), event notification server 112 issues an independent request by itself to query which messages have been marked deleted (and hence will get deleted by the client request for “EXPUNGE”).

Event 3 (see step 515, FIG. 5A) represents event notification server 112 receiving a response to the event query from email server 105. The email server 105 provides a response listing all the unique identifiers (UID) associated with the messages marked for deletion. Only upon receiving the response to the event query, does the event notification server 112 forward the client's “EXPUNGE” request to the email server 105.

Event 4 (see step 520, FIG. 5A) represents the generation of an event notification indicating that the message ids have been deleted.

Event 5 (see step 525, FIG. 5A) represents event notification server 112 issuing the client's Expunge request to email server 105.

Event 6 (see step 530, FIG. 5A) represents the email servers 105 response to the Expunge request. The response contains the UIDs of the expunged messages.

Event 7 (see step 535, FIG. 5A) represents the forwarding of the UIDs from event notification server 112 to the client initiating the expunge request.

In this way, the client is provided with confirmation that the requested messages have been deleted. Accordingly, any indication that the message is stored (e.g., automated voice announcement of number of messages stored or icon) would be updated to reflect that the message is no longer available.

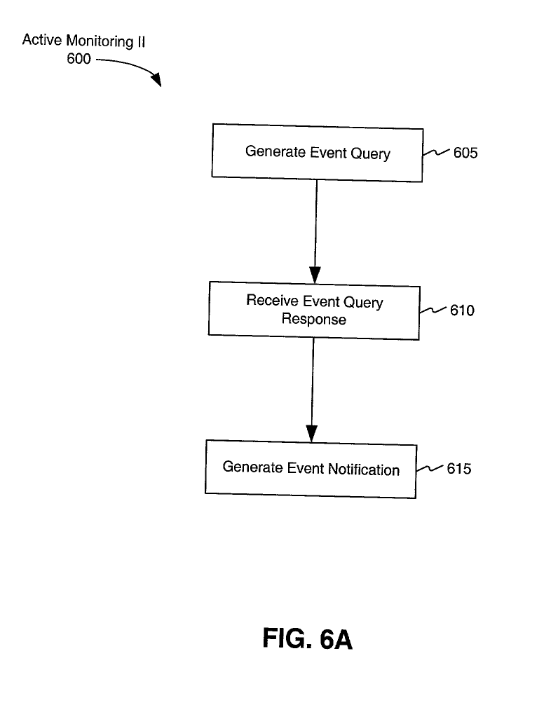

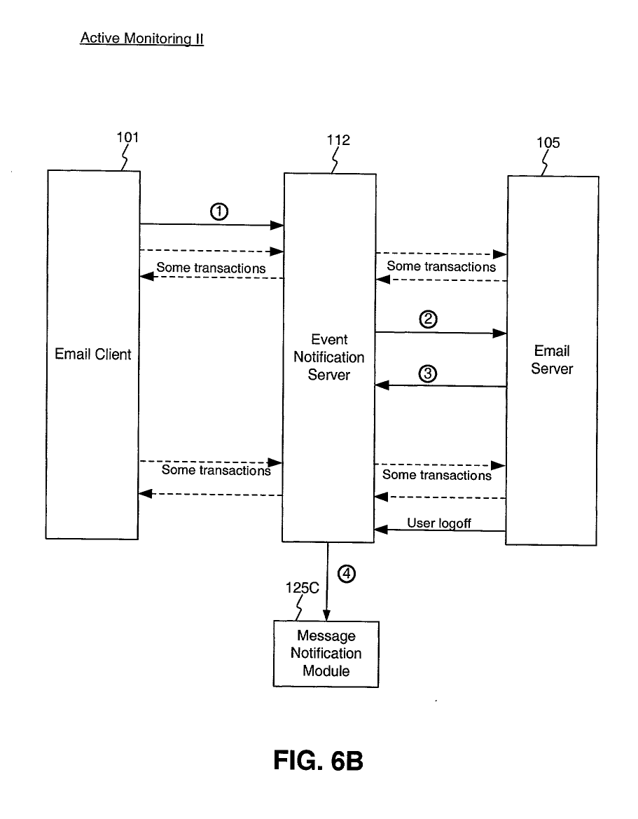

FIG. 6A is a flowchart of a method 600 (steps 605-615) showing the second type of active monitoring of event requests and generation of event notifications according to a second embodiment of the present invention. In this example, the event notifications are not based on client requests.

In step 605, event notification server 112 generates an event query. The event query is used to gather information needed to provide such services as message waiting notification.

In step 610, event notification server 112 receives a event query response from email server 105.

In step 615, event notification server 112 generates an event notification based upon the event query response received in step 610.

FIG. 6B shows an example implementation of the second type of active monitoring (i.e., active monitoring based on client requests) according to flow 600 described above.

Event 1 represents the initiation of a user session.

Event 2 (see step 605, FIG. 6A) represents the generation of an event query. In this example, event notification server 112, in order to determine the message waiting status of the mailbox, periodically issues queries to find out whether the mailbox has any unread messages. (In case of an unread message, message waiting lamp has to be turned ON, otherwise it should be turned off.)

Event 3 (see step 610, FIG. 6A) represents the response to the event query. In the present example, the response indicates that there are no unread messages.

Event 4 (see step 615, FIG. 6A) represents the generation of an event notification.

In this way, the generated event notification can be used to inform message notification module 125C to turn off the message waiting lamp on the user's phone. The illustrated exchanges of additional transactions between the client, event notification server, and email server is intended to demonstrate that the queries generated by event notification server 112 are independent of any request initiated by the client.

Referring to FIG. 3, an example of a computer system 300 is shown. Computer system 300 can be used to implement computer program product embodiments of the present invention. This example computer system is illustrative and not intended to limit the present invention. Computer system 300 represents any single or multi-processor computer. Single-threaded and multi-threaded computers can be used. Unified or distributed memory systems can be used.

IV. Example Computer System

Computer system 300 includes one or more processors, such as processor 304. One or more processors 304 can execute software and implement all or part of the features of the present invention described herein. Each processor 304 is connected to a communication infrastructure 302 (e.g., a communications bus, cross-bar, or network). After reading this description, it will become apparent to a person skilled in the relevant art how to implement the invention using other computer systems and/or computer architectures.

Computer system 300 also includes a main memory 312, preferably random access memory (RAM), and can also include secondary memory 314. Secondary memory 314 can include, for example, a hard disk drive 316 and/or a removable storage drive 318, representing a floppy disk drive, a magnetic tape drive, an optical disk drive, etc. The removable storage drive 318 reads from and/or writes to a removable storage unit 320 in a well-known manner. Removable storage unit 320 represents a floppy disk, magnetic tape, optical disk, etc., which is read by and written to by removable storage drive 318. As will be appreciated, the removable storage unit 320 includes a computer usable storage medium having stored therein computer software and/or data.

In alternative embodiments, secondary memory 314 may include other similar means for allowing computer programs or other instructions to be loaded into computer system 300. Such means can include, for example, a removable storage unit 324 and an interface 322. Examples can include a program cartridge and cartridge interface (such as that found in video game devices), a removable memory chip (such as an EPROM, or PROM) and associated socket, and other removable storage units 324 and interfaces 322 which allow software and data to be transferred from the removable storage unit 324 to computer system 300.

Computer system 300 can also include a communications interface 330. Communications interface 330 allows software and data to be transferred between computer system 300 and external devices via communications path 335. Examples of communications interface 330 can include a modem, a network interface (such as Ethernet card), a communications port, etc. Software and data transferred via communications interface 330 are in the form of signals which can be electronic, electromagnetic, optical or other signals capable of being received by communications interface 330, via communications path 335. Note that communications interface 330 provides a means by which computer system 300 can interface to a network such as the Internet.

The present invention can be implemented using software running (that is, executing) in an environment similar to that described above with respect to FIG. 3. In this document, the term “computer program product” is used to generally refer to removable storage unit 320, a hard disk installed in hard disk drive 318, or a carrier wave or other signal carrying software over a communication path 335 (wireless link or cable) to communication interface 330. A computer useable medium can include magnetic media, optical media, or other recordable media, or media that transmits a carrier wave. These computer program products are means for providing software to computer system 300.

Computer programs (also called computer control logic) are stored in main memory 312 and/or secondary memory 314. Computer programs can also be received via communications interface 330. Such computer programs, when executed, enable the computer system 300 to perform the features of the present invention as discussed herein. In particular, the computer programs, when executed, enable the processor 304 to perform the features of the present invention. Accordingly, such computer programs represent controllers of the computer system 300.

In an embodiment where the invention is implemented using software, the software may be stored in a computer program product and loaded into computer system 300 using removable storage drive 318, hard drive 316, or communications interface 330. Alternatively, the computer program product may be downloaded to computer system 300 over communications path 335. The control logic (software), when executed by the one or more processors 304, causes the processor(s) 304 to perform the functions of the invention as described herein.

In another embodiment, the invention is implemented primarily in firmware and/or hardware using, for example, hardware components such as application specific integrated circuits (ASICs). Implementation of a hardware state machine so as to perform the functions described herein will be apparent to a person skilled in the relevant art.

### V. CONCLUSION

While various embodiments of the present invention have been described above, it should be understood that they have been presented by way of example only, and not limitation. Thus, the breadth and scope of the present invention should not be limited by any of the above-described exemplary embodiments, but should be define only in accordance with the following claims and their equivalents.

What is claimed is:

1. An event notification system comprising:
an email server for storing a plurality of email messages;
at least one client from which at least one event request is initiated;
a message handler that monitors said at least one event request, forwards said event request to said email server, and forwards an event response based on said at least one event request to said at least one client; and
an event listener that generates an event notification when said at least one event request corresponds to a subscriber event registration.

2. The event notification system of claim 1, further comprising a voice-mail state machine coupled to said event listener, wherein said voice-mail state machine provides access to a plurality of voice messages and facsimile messages.

3. The event notification system of claim 1, wherein said message handler includes at least one communication protocol handler.

4. The event notification system of claim 1, further comprising a plurality of event notification requesters that receive said event notification generated by said event listener.

5. The event notification system of claim 2, wherein said at least one event requests includes a request to log-on a user.

6. The event notification system of claim 2, wherein said at least one event request includes a request to log-off a user.

7. The event notification system of claim 2, wherein said at least one event request includes a request to mark said email message as read.

8. The event notification system of claim 2, wherein said at least one event request includes a request to mark said email message as unread.

9. The event notification system of claim 2, wherein said at least one event request includes a request to mark said voice message as played.

10. The event notification system of claim 2, wherein said at least one event request includes a request to mark said voice message as unplayed.

11. The event notification system of claim 2, wherein said at least one event request includes a request to delete said email message or said voice message.

12. The event notification system of claim 1, wherein said event listener comprises:
a registration manager that receives and stores one or more event notification requests from said plurality of event notification requesters; and
a notification generator for generating said event notification.

13. The event notification system of claim 1, wherein said event listener actively monitors said event requests.

14. The event notification system of claim 1, wherein said event listener passively monitors said event requests.

15. A method for providing event notification in a unified messaging system, the method comprising:
a plurality of email messages in an email server;
initiating a user session from an email client;
monitoring the user session with a event notification server to identify an event occurrence; and
issuing an event notification to an event subscriber in response to the identified event occurrence.

16. A method for providing event notification in a unified messaging system, the method comprising:
receiving an event request;
forwarding the event request to an email server;
receiving a response to the event request;
determining if the event request is a subscriber event; and
generating an event notification when the event request is a subscriber event.

17. A method for generating an event notification in a unified messaging system, the method comprising the steps of:
(a) receiving an event request from a client;
(b) generating an event query;
(c) receiving an event query response to the event query;
(d) generating an event notification, the event notification comprising the event request and the event query response;
(e) forwarding the event request to an email server;
(f) receiving a response to the event request; and
(g) forwarding the response to the client.

18. The method of claim 17, wherein said generating an event query step (b) requests a list of message identifiers referenced in the event request.

19. The method of claim 18, wherein the event query response includes said list of message identifiers requested in said generating an event query step (b).

20. A method for generating an event notification in a unified messaging system, the method comprising the steps of:
(a) generating an event query;
(b) receiving an event query response to the event query;
(c) generating an event notification, the event notification comprising the event request and the event query response.

21. The method of claim 20, wherein said generating an event query step (a) generates a query to determine if there are any unread messages.

22. The method of claim 21, wherein said generating an event notification step (c) generates an event notification used to provide indication that a message is waiting.
